(19) United States
(12) Patent Application Publication
(10) Pub. No.: US 2023/0219579 A1
(43) Pub. Date: Jul. 13, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventors: Kenji YAMAGUCHI, Miyoshi-shi (JP); Yusuke KUZUYA, Toyota-shi (JP); Yoshikazu JIKUHARA, Miyoshi-shi (JP); Kosuke SAKAKIBARA, Toyota-shi (JP); Takashi HAYASHI, Nagoya-shi (JP)

(21) Appl. No.: 17/974,534

(22) Filed: Oct. 27, 2022

(30) Foreign Application Priority Data
Jan. 13, 2022 (JP) 2022-004015

(51) Int. Cl. B60W 40/09; B60W 50/10; B60W 50/14

(52) U.S. Cl. CPC B60W 40/09; B60W 50/10; B60W 50/14; B60W 2050/146; B60W 2540/215

(57) ABSTRACT

An information processing device includes: a reception unit that receives setting, by a driver of a vehicle, of a provision range of vehicle information about the vehicle to be provided to a user who wishes to use the vehicle information, before the vehicle information is provided to the user; an acquisition unit that acquires the vehicle information; and a provision unit that provides the vehicle information that is included in the provision range acquired by the acquisition unit to the user.

### CROSS-REFERENCE TO RELATED APPLICATION

This application claims priority to Japanese Patent Application No. 2022-004015 filed on Jan. 13, 2022, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2020-194280 (JP 2020-194280 A) discloses a technique in which an incentive given to a user becomes higher as the degree of importance of environmental information becomes higher.

### SUMMARY

Here, when providing vehicle information about a vehicle, like the environmental information in JP 2020-194280 A, to the outside, it is desirable not to provide the vehicle information without the driver’s permission to prevent the information from being used for unintended purposes. However, if whether to provide the vehicle information is confirmed on each occasion of providing the vehicle information, the confirmation task of the driver becomes complicated.

An object of the present disclosure is to provide an information processing device, an information processing method, and a storage medium that can provide vehicle information that is specified beforehand by a driver.

The information processing device according to claim 1 includes: a reception unit that receives setting, by a driver of a vehicle, of a provision range of vehicle information about the vehicle to be provided to a user who wishes to use the vehicle information, before the vehicle information is provided to the user; an acquisition unit that acquires the vehicle information; and a provision unit that provides the vehicle information that is included in the provision range acquired by the acquisition unit to the user.

In the information processing device according to claim 1, the reception unit receives setting, by the driver, of the provision range of the vehicle information to be provided to the user before the vehicle information is provided to the user. The acquisition unit acquires the vehicle information. Then, the provision unit provides the vehicle information that is included in the provision range acquired by the acquisition unit to the user. In this way, the vehicle information included in the provision range that is set before the vehicle information is provided is provided to the user, and thus this information processing device can provide the vehicle information that is specified beforehand by the driver. Since the vehicle information included in the provision range that is set before the vehicle information is provided is provided to the user, this information processing device can reduce the confirmation task performed by the driver when providing the vehicle information.

The information processing device according to claim 2 is the information processing device according to claim 1, wherein, as the provision range, the reception unit receives setting of a range of at least one of types, provision destinations, and purposes of use of the vehicle information permitted by the driver.

In the information processing device according to claim 2, as the provision range, the reception unit receives setting of a range of at least one of types, provision destinations, and purposes of use of the vehicle information permitted by the driver. Thus, this information processing device can prevent a situation where the vehicle information for which a range of at least one of types, provision destinations, and purposes of use that is not intended by the driver is set is provided to the user.

The information processing device according to claim 3 is the information processing device according to claim 1, including a granting unit that grants the driver a privilege based on the vehicle information having been provided to the user, wherein the granting unit grants the driver a more advantageous privilege when the provision range is wider.

In the information processing device according to claim 3, the granting unit grants the driver a privilege based on the vehicle information having been provided to the user. The granting unit grants the driver a more advantageous privilege when the provision range is wider. Thus, according to this information processing device, the driver is expected to expand the provision range for the user to obtain an advantageous privilege, and the user can use valuable vehicle information.

The information processing device according to claim 4 is the information processing device according to claim 3, wherein a plurality of privileges with varying degrees of advantageousness is provided, and the information processing device includes a presentation unit that presents combinations of the provision ranges for the respective privileges when the provision unit provides the vehicle information to the user.

In the information processing device according to claim 4, a plurality of privileges with varying degrees of advantageousness is provided. The presentation unit presents combinations of the provision ranges for the respective privileges when the provision unit provides the vehicle information to the user. Thus, this information processing device can provide the driver with criteria for determining whether to expand the provision range for the user.

The information processing device according to claim 5 is the information processing device according to claim 1, including a setting unit that receives re-setting of the provision range when the provision unit provides the vehicle information to the user.

In the information processing device according to claim 5, the setting unit receives re-setting of the provision range when the provision unit provides the vehicle information to the user. Thus, when providing the vehicle information to the user, this information processing device allows the provision range that has been once set to be expanded or narrowed according to the privilege that the driver desires to obtain.

The information processing device according to claim 6 is the information processing device according to claim 5, wherein, as a timing when the provision unit provides the vehicle information to the user, the setting unit receives re-setting of the provision range in a confirmation screen that makes the driver confirm the vehicle information to be provided to the user.

In the information processing device according to claim 6, as the timing when the provision unit provides the vehicle information to the user, the setting unit receives re-setting of the provision range in the confirmation screen that makes the driver confirm the vehicle information to be provided to the user. Thus, this information processing device can make the driver confirm the vehicle information for which the provision range has been re-set.

The information processing device according to claim 7 is the information processing device according to claim 1, wherein the acquisition unit acquires the vehicle information that is included in the provision range received by the reception unit.

In the information processing device according to claim 7, the acquisition unit acquires the vehicle information that is included in the provision range received by the reception unit. Thus, this information processing device can prevent vehicle information that is not intended by the driver from being acquired.

In the information processing method according to claim 8, a computer executes the following processes: receiving setting, by a driver of a vehicle, of a provision range of vehicle information about the vehicle to be provided to a user who wishes to use the vehicle information, before the vehicle information is provided to the user; acquiring the vehicle information; and providing the vehicle information that is included in the acquired provision range to the user.

The storage medium according to claim 9 stores an information processing program that makes a computer execute the following processes: receiving setting, by a driver of a vehicle, of a provision range of vehicle information about the vehicle to be provided to a user who wishes to use the vehicle information, before the vehicle information is provided to the user; acquiring the vehicle information; and providing the vehicle information that is included in the acquired provision range to the user.

As has been described above, the information processing device, the information processing method, and the storage medium according to the present disclosure can provide vehicle information that is specified beforehand by the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system according to an embodiment;

FIG. 2 is a block diagram showing the hardware configurations of a business operator terminal and a user terminal according to the embodiment;

FIG. 3 is a block diagram showing the configuration of a storage unit of the business operator terminal according to the embodiment;

FIG. 4 is a block diagram showing an example of the functional configuration of the business operator terminal according to the embodiment;

FIG. 5 is a block diagram showing the hardware configuration of a vehicle according to the embodiment;

FIG. 6 is a flowchart showing the flow of a provision process by the business operator terminal according to the embodiment;

FIG. 7 is a first display example displayed on a monitor of the vehicle according to the embodiment;

FIG. 8 is a second display example displayed on the monitor of the vehicle according to the embodiment;

FIG. 9 is a third display example displayed on the monitor of the vehicle according to the embodiment;

FIG. 10 is a fourth display example displayed on the monitor of the vehicle according to the embodiment;

FIG. 11 is a fifth display example displayed on the monitor of the vehicle according to the embodiment; and

FIG. 12 is a sixth display example displayed on the monitor of the vehicle according to the embodiment.

### DETAILED DESCRIPTION OF EMBODIMENTS

An information processing system 10 according to embodiments will be described below. The information processing system 10 according to the embodiments is a system that provides vehicle information about a vehicle that is specified beforehand by a driver to a user who wishes to use the vehicle information.

### First Embodiment

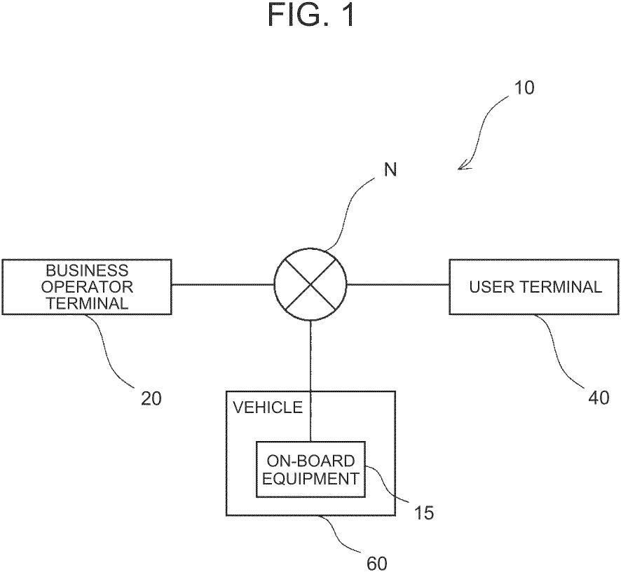

First, the information processing system 10 according to a first embodiment will be described. FIG. 1 is a diagram showing a schematic configuration of the information processing system 10.

As shown in FIG. 1, the information processing system 10 includes a business operator terminal 20, a user terminal 40, and a vehicle 60. The business operator terminal 20, the user terminal 40, and on-board equipment 15 installed in the vehicle 60 are connected through a network N so as to be communicable with one another.

The business operator terminal 20 that is one example of the information processing device is a server computer owned by a predetermined business operator. The business operator terminal 20 acquires vehicle information about the vehicle 60 from the vehicle 60 through the network N. Among the acquired pieces of vehicle information, the business operator terminal 20 provides those pieces of vehicle information that are specified beforehand by a driver of the vehicle 60 to a user who wishes to use the vehicle information by sending the vehicle information to the user terminal 40. Examples of the user include a maintenance company that performs maintenance of vehicles, a distributor that sells vehicles, and an insurance company that handles insurance products relating to vehicles.

The user terminal 40 is a terminal owned by the user. As the user terminal 40, for example, a general-purpose computer device, such as a server computer or a personal computer (PC), or a portable personal computer (note PC), a smartphone, or a tablet terminal is used. In the first embodiment, as one example, the user terminal 40 is a PC. As described above, the user terminal 40 acquires the vehicle information that is specified beforehand by the driver from the business operator terminal 20 through the network N.

While the vehicle 60 may be any one of an engine vehicle, a hybrid electric vehicle, and a battery electric vehicle, the vehicle 60 in the first embodiment is an engine vehicle as one example. As described above, the vehicle 60 sends the vehicle information to the business operator terminal 20 through the network N.

In FIG. 1, only one vehicle 60 is shown as the vehicle and only one user terminal 40 is shown as the user terminal. However, the present disclosure is not limited to this example and there may be pluralities of vehicles and user terminals.

Here, in the information processing system 10, vehicle information is managed using the block-chain technology as one example. Thus, in the information processing system 10, the vehicle information can be shared in a block chain among the business operator terminal 20, the user terminal 40, and the on-board equipment 15 installed in the vehicle 60, among the plurality of user terminals 40, and among the plurality of pieces of on-board equipment 15.

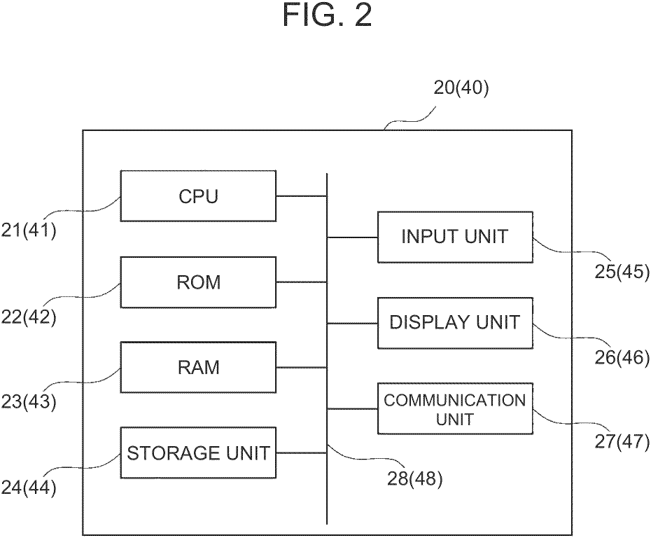

Next, the hardware configurations of the business operator terminal 20 and the user terminal 40 will be described. FIG. 2 is a block diagram showing the hardware configurations of the business operator terminal 20 and the user terminal 40. As the business operator terminal 20 and the user terminal 40 basically have a general computer configuration, the business operator terminal 20 will be described as a representative.

As shown in FIG. 2, the business operator terminal 20 includes a central processing unit (CPU) 21, a read-only memory (ROM) 22, a random-access memory (RAM) 23, a storage unit 24, an input unit 25, a display unit 26, and a communication unit 27. These components are communicably connected to one another through a bus 28.

The CPU 21 is a central arithmetic processing unit and executes various programs and controls parts. Specifically, the CPU 21 reads a program from the ROM 22 or the storage unit 24 and executes the program using the RAM 23 as a work area. The CPU 21 performs control of the aforementioned components and various arithmetic processes in accordance with programs recorded in the ROM 22 or the storage unit 24.

The ROM 22 stores various programs and various pieces of data. As a work area, the RAM 23 temporarily stores programs or data.

The storage unit 24 is formed by a storage device, such as a hard disk drive (HDD), a solid-state drive (SSD), or a flash memory, and stores various programs and various pieces of data.

The input unit 25 includes a pointing device, such as a mouse, a keyboard, a microphone, and a camera, and is used to make various inputs.

The display unit 26 is, for example, a liquid crystal display and displays various pieces of information. As the display unit 26, a touch panel type that functions also as the input unit 25 may be adopted.

The communication unit 27 is an interface for communicating with other devices. For this communication, for example, a wired communication standard such as Ethernet ® or FDDI, or a wireless communication standard such as 4G, 5G, or Wi-Fi ® is used.

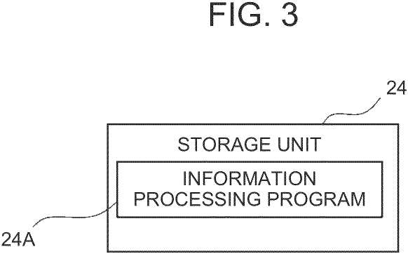

FIG. 3 is a block diagram showing the configuration of the storage unit 24 of the business operator terminal 20.

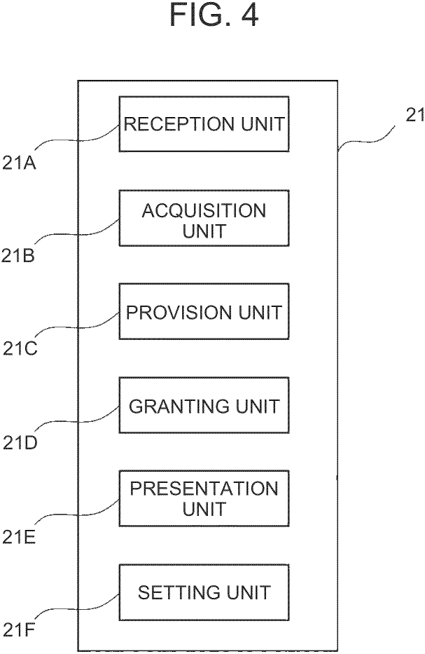

As shown in FIG. 3, the storage unit 24 stores an information processing program 24A that makes the CPU 21 of the business operator terminal 20 function as components of the functional configuration shown in FIG. 4 to be described later. When executing this information processing program 24A, the business operator terminal 20 executes a process based on the information processing program 24A using the hardware resources shown in FIG. 2.

Next, the functional configuration of the business operator terminal 20 will be described.

FIG. 4 is a block diagram showing an example of the functional configuration of the business operator terminal 20.

As shown in FIG. 4, the CPU 21 of the business operator terminal 20 has, as components of the functional configuration, a reception unit 21A, an acquisition unit 21B, a provision unit 21C, a granting unit 21D, a presentation unit 21E, and a setting unit 21F. Each component of the functional configuration is realized as the CPU 21 reads the information processing program 24A stored in the storage unit 24 and executes this program.

The reception unit 21A receives setting, by the driver, of the provision range of the vehicle information to be provided to the user, before the vehicle information is provided to the user. As the provision range, the reception unit 21A receives a range of types and a range of purposes of use of the vehicle information permitted by the driver. Examples of purposes of use of the vehicle information include business purposes and maintenance purposes. Here, as the timing before the vehicle information is provided to the user, the reception unit 21A receives setting of the range of types and the range of purposes of use of the vehicle information in a setting screen for setting the provision range. The range of types and the range of purposes of use of the vehicle information are set according to contents of operation that the driver performs in the setting screen on an input switch 77 or a monitor 78, to be described later, that are included in the vehicle 60.

The acquisition unit 21B acquires the vehicle information. The acquisition unit 21B acquires, as the vehicle information, for example, a steering angle, an acceleration, a vehicle speed, and direction indicator operation in the vehicle 60 that are detected by a steering angle sensor 71, an acceleration sensor 72, a vehicle speed sensor 73, and a direction indicator switch 74, to be described later, that are included in the vehicle 60. The acquisition unit 21B acquires, as the vehicle information, an engine speed, an engine torque, fuel efficiency, accelerator operation, and on and off of an ignition switch (not shown) in the vehicle 60 that are detected by an ECU 70C, to be described later, that is included in the vehicle 60. The acquisition unit 21B acquires, as the vehicle information, a vehicle ID of the vehicle 60 into which the driver has gotten. The acquisition unit 21B acquires, as the vehicle information, an image taken by the camera 76, to be described later, that is included in the vehicle 60. The acquisition unit 21B acquires, as the vehicle information, a current position of the vehicle 60 measured by a GPS device 80, to be described later, that is included in the vehicle 60. These pieces of information are some of the vehicle information that the acquisition unit 21B can acquire from the vehicle 60, and the acquisition unit 21B acquires, as the vehicle information, also other pieces of information about the vehicle 60 than those mentioned above from the vehicle 60.

The provision unit 21C provides the vehicle information that is included in the provision range acquired by the acquisition unit 21B to the user. Specifically, in the first embodiment, among the pieces of vehicle information acquired by the acquisition unit 21B, the provision unit 21C provides those pieces of vehicle information that are included in the provision range received by the reception unit 21A to the user by sending the vehicle information to the user terminal 40.

The granting unit 21D grants the driver a privilege based on the vehicle information having been provided to the user. Examples of the privilege include money, various courtesies, and goods. In the first embodiment, the privilege is various courtesies as one example. Here, when granting the drier the privilege, the granting unit 21D generates privilege information according to the privilege to be granted, and grants the driver the generated privilege information by sending it to the vehicle 60. When the privilege information is sent to the vehicle 60, the driver can use the privilege by performing a predetermined operation on the input switch 77 or the monitor 78, and can, for example, get a discount on a parking fee or a highway toll by the various courtesies.

In the first embodiment, as a plurality of privileges with varying degrees of advantageousness, a “low” privilege, a “medium” privilege that is more advantageous than the “low” privilege, and a “high” privilege that is more advantageous than the “medium” privilege are provided. The granting unit 21D grants the driver a more advantageous privilege when the provision range is wider. Examples of an advantageous privilege include more money, various courtesies with larger discount amounts, and goods of higher rarity value than the privilege one level below it. In the first embodiment, as the privilege becomes more advantageous, the discount amounts of the various courtesies become larger. In the first embodiment, that the provision range is wide means at least either that the number of types of vehicle information included in the provision range is large or that the number of permitted purposes of use is large.

The presentation unit 21E presents combinations of the provision ranges for the respective privileges when the provision unit 21C provides the vehicle information to the user. In the first embodiment, the presentation unit 21E presents combinations of the ranges of types and the ranges of purposes of use of the vehicle information that need to be provided to be granted the “low” privilege, the “medium” privilege, and the “high” privilege. Here, as the timing when the provision unit 21C provides the vehicle information to the user, the presentation unit 21E presents the combinations of the ranges of types and the ranges of purposes of use of the vehicle information in a confirmation screen that makes the driver confirm the vehicle information to be provided to the user.

The setting unit 21F receives re-setting of the provision range when the provision unit 21C provides the vehicle information to the user. In the first embodiment, as the timing when the provision unit 21C provides the vehicle information to the user, the setting unit 21F receives re-setting of the provision range in the confirmation screen.

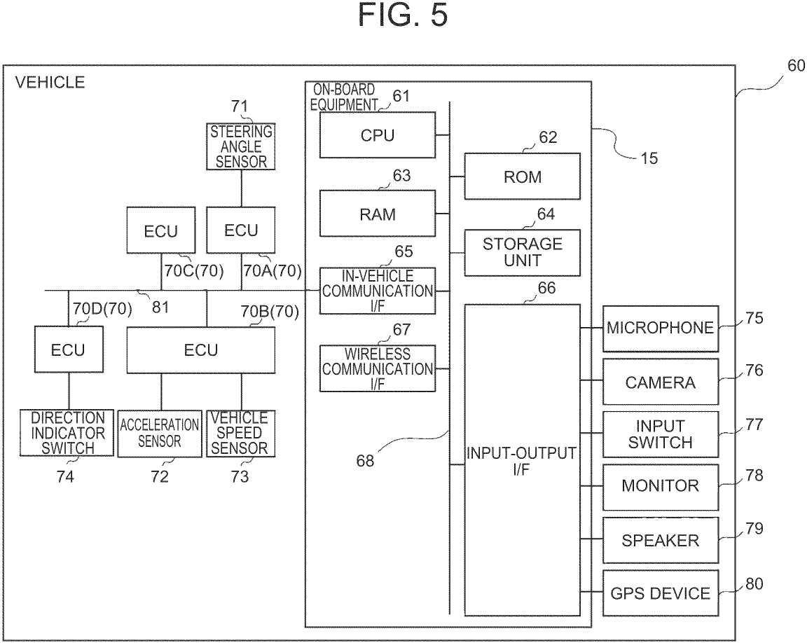

Next, the hardware configuration of the vehicle 60 will be described. FIG. 5 is a block diagram showing the hardware configuration of the vehicle 60.

As shown in FIG. 5, the vehicle 60 includes, in its configuration, the on-board equipment 15, a plurality of electronic control units (ECUs) 70, the steering angle sensor 71, the acceleration sensor 72, the vehicle speed sensor 73, the direction indicator switch 74, a microphone 75, the camera 76, the input switch 77, the monitor 78, a speaker 79, and the GPS device 80.

The on-board equipment 15 includes, in its configuration, a CPU 61, an ROM 62, an RAM 63, a storage unit 64, an in-vehicle communication interface (I/F) 65, an input-output I/F 66, and a wireless communication I/F 67. The CPU 61, the ROM 62, the RAM 63, the storage unit 64, the in-vehicle communication I/F 65, the input-output I/F 66, and the wireless communication I/F 67 are communicably connected to one another through an internal bus 68.

The CPU 61 is a central arithmetic processing unit and executes various programs and controls parts. Specifically, the CPU 61 reads a program from the ROM 62 or the storage unit 64 and executes the program using the RAM 63 as a work area. The CPU 61 performs control of the aforementioned components and various arithmetic processes in accordance with programs stored in the ROM 62 or the storage unit 64.

The ROM 62 stores various programs and various pieces of data. As a work area, the RAM 63 temporarily stores programs or data.

The storage unit 64 is formed by a storage device, such as an HDD, an SSD, or a flash memory and stores various programs and various pieces of data. In the first embodiment, the storage unit 64 stores the vehicle ID that is vehicle information.

The in-vehicle communication I/F 65 is an interface for connecting to the ECU 70. For this interface, a communication standard complying with the CAN protocol is used. The in-vehicle communication I/F 65 is connected to an external bus 81.

The ECUs 70 are provided for the respective functions of the vehicle 60. In the first embodiment, an ECU 70A, an ECU 70B, an ECU 70C, and an ECU 70D are provided. One example of the ECU 70A is an electric power steering ECU, and the steering angle sensor 71 is connected to the ECU 70A. One example of the ECU 70B is a vehicle stability control (VSC) ECU, and the acceleration sensor 72 and the vehicle speed sensor 73 are connected to the ECU 70B. In addition to the acceleration sensor 72 and the vehicle speed sensor 73, a yaw rate sensor may also be connected to the ECU 70B.

One example of the ECU 70C is an engine ECU, and the ECU 70C detects the engine speed and the engine torque in the vehicle 60 to control the engine. The ECU 70C detects the fuel efficiency based on a fuel flow rate acquired from sensors (not sown). Further, the ECU 70C detects accelerator operation in the vehicle 60. The engine speed, engine torque, fuel efficiency, accelerator operation, and on and off of the ignition switch detected by the ECU 70C are stored in the storage unit 64 as well as sent to the business operator terminal 20 as the vehicle information. One example of the ECU 70D is a steering ECU, and the direction indicator switch 74 is connected to the ECU 70D. The direction indicator switch 74 is provided in a steering column that is used to activate the direction indicator. The ECU 70D detects the driver’s operation of the direction indicator switch 74 as direction indicator operation. The direction indicator operation detected by the ECU 70D is stored in the storage unit 64 as well as sent to the business operator terminal 20 as the vehicle information.

The steering angle sensor 71 is a sensor that detects the steering angle of a steering wheel. The steering angle detected by the steering angle sensor 71 is stored in the storage unit 64 as well as sent to the business operator terminal 20 as the vehicle information.

The acceleration sensor 72 is a sensor that detects acceleration acting on the vehicle 60. One example of the acceleration sensor 72 is a three-axis acceleration sensor, which detects acceleration exerted in a vehicle front-rear direction as an X-axis direction, a vehicle width direction as a Y-axis direction, and a vehicle height direction as a Z-axis direction. The acceleration detected by the acceleration sensor 72 is stored in the storage unit 64 as well as sent to the business operator terminal 20 as the vehicle information.

The vehicle speed sensor 73 is a sensor that detects the vehicle speed of the vehicle 60. The vehicle speed sensor 73 is, for example, a sensor provided on a wheel. The vehicle speed detected by the vehicle speed sensor 73 is stored in the storage unit 64 as well as sent to the business operator terminal 20 as the vehicle information.

The input-output I/F 66 is an interface for communicating with the microphone 75, the camera 76, the input switch 77, the monitor 78, the speaker 79, and the GPS device 80 installed in the vehicle 60.

The microphone 75 is a device that is provided in a front pillar, a dashboard, etc. of the vehicle 60 and collects voices produced by the driver of the vehicle 60. The microphone 75 may be provided in the camera 76 to be described later.

The camera 76 is an imaging device that takes images using an imaging element, for example, a charge-coupled device (CCD) image sensor or a complementary metal-oxide semiconductor (CMOS) image sensor. The camera 76 is provided at a front part of the vehicle 60, for example, and images a front side of the vehicle. Images taken by the camera 76 are used, for example, to recognize an inter-vehicle distance to a vehicle ahead that travels on a front side of the vehicle, lanes, traffic lights, etc. The images taken by the camera 76 are stored in the storage unit 64 as well as sent to the business operator terminal 20 as the vehicle information. The camera 76 may be connected to the on-board equipment 15 via the ECU 70 (e.g., camera ECU).

The input switch 77 is a switch that is provided in an instrument panel, a center console, the steering wheel, etc. and used to input operation by a finger of the driver. As the input switch 77, for example, a push-button numeric keypad or a touch pad can be adopted.

The monitor 78 is a liquid crystal monitor that is provided in the instrument panel, a meter panel, etc. and displays images relating to suggestion of action about a function of the vehicle 60 and to explanation of the function. The monitor 78 may be provided as a touch panel that includes the function of the input switch 77.

The speaker 79 is a device that is provided in the instrument panel, the center console, the front pillar, the dashboard, etc. and outputs voice relating to suggestion of action about a function of the vehicle 60 and to explanation of the function. The speaker 79 may be provided in the monitor 78.

The GPS device 80 is a device that measures the current position of the vehicle 60. The GPS device 80 includes an antenna (not shown) that receives signals from a GPS satellite. The current position of the vehicle 60 measured by the GPS device 80 is stored in the storage unit 64 as well as sent to the business operator terminal 20 as the vehicle information. The GPS device 80 may be connected to the on-board equipment 15 via a car navigation system connected to the ECU 70 (e.g., multimedia ECU).

The wireless communication I/F 67 is a wireless communication module for communicating with other devices. For the wireless communication module, a communication standard such as 5G, LTE, or Wi-Fi ® is used. The wireless communication I/F 67 is connected to the network N.

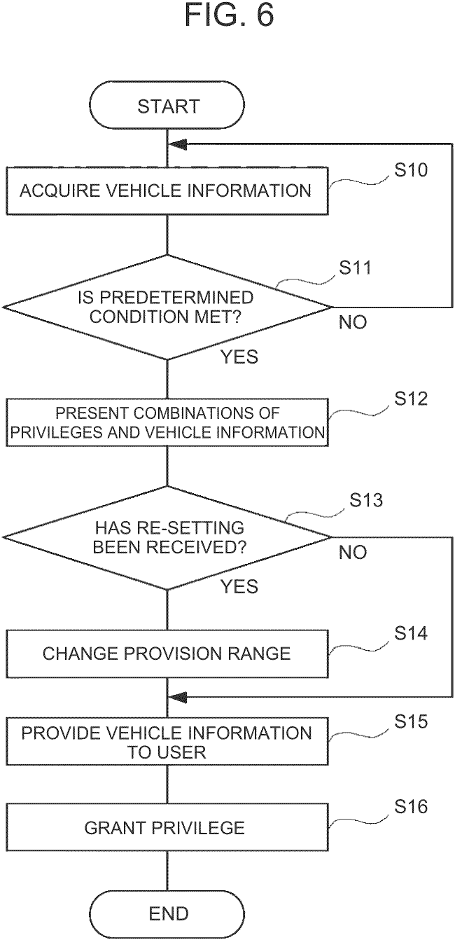

FIG. 6 is a flowchart showing the flow of a provision process performed by the business operator terminal 20 to provide the vehicle information that is specified beforehand by the driver to the user. This provision process is performed as the CPU 21 reads the information processing program 24A from the storage unit 24 and decompresses and executes the program in the RAM 23. The provision process is started, for example, when the ignition switch of the vehicle 60 is turned on. As a premise for the provision process, it is assumed that setting, by the driver, of the provision range of the vehicle information to be provided to the user is completed.

In step S10 shown in FIG. 6, the CPU 21 acquires the vehicle information from the vehicle 60. Then, the CPU 21 moves to step S11. In the first embodiment, the vehicle information is sent from the vehicle 60 to the business operator terminal 20, for example, on a regular basis.

In step S11, the CPU 21 determines whether a predetermined condition is met. When the CPU 21 determines that the predetermined condition is met (step S11: YES), the CPU 21 moves to step S12. On the other hand, when the CPU 21 determines that the predetermined condition is not met (step S11: NO), the CPU 21 returns to step S10. The CPU 21 determines that the predetermined condition is met, for example, when the ignition switch of the vehicle 60 is turned off.

In step S12, the CPU 21 presents combinations of the provision ranges for the respective privileges. Then, the CPU 21 moves to step S13.

In step S13, the CPU 21 determines whether re-setting of the provision range of the vehicle information to be provided to the user has been received. When the CPU 21 determines that re-setting has been received (step S13: YES), the CPU 21 moves to step S14. On the other hand, when the CPU 21 determines that re-setting has not been received (step S13: NO), the CPU 21 moves to step S15.

In step S14, the CPU 21 changes the provision range to the contents of the re-setting received in step S13. Then, the CPU 21 moves to step S15.

In step S15, the CPU 21 provides the vehicle information that is included in the provision range set by the driver to the user by sending it to the user terminal 40. Then, the CPU 21 moves to step S16.

In step S16, the CPU 21 generates privilege information based on the vehicle information provided to the user in step S15, and grants the driver the generated privilege information by sending it to the vehicle 60. Then, the CPU 21 ends the provision process.

Next, display examples of the setting screen will be described.

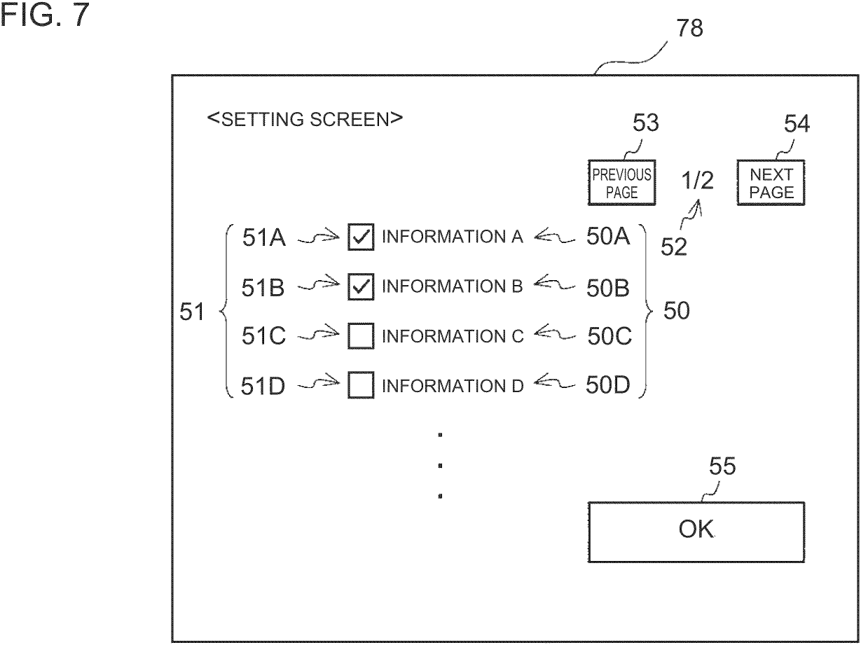

FIG. 7 is a first display example displayed on the monitor 78 of the vehicle 60. The CPU 21 of the business operator terminal 20 displays the setting screen shown in FIG. 7 on the monitor 78, for example, upon receiving a predetermined operation on the input switch 77 or the monitor 78. The vehicle information is not sent from the business operator terminal 20 to the user terminal 40 unless setting of the provision range of the vehicle information to be provided to the user is completed in the setting screen.

In the setting screen shown in FIG. 7, an information display part 50, checkboxes 51, a page display part 52, a previous page button 53, a next page button 54, and an OK button 55 are displayed.

The information display part 50 is a part showing the types of vehicle information. As one example, the information display part 50 shown in FIG. 7 displays first information 50A showing that the type of vehicle information is information A, second information 50B showing that the type is information B, third information 50C showing that the type is information C, and fourth information 50D showing that the type is information D. The number of pieces of information displayed in the information display part 50 is not limited to four but may be larger or smaller than four.

The checkboxes 51 are portions that receive selection, by the driver, of the range of types of vehicle information to be provided to the user. As one example, in FIG. 7, a first checkbox 51A that receives selection of the information A, a second checkbox 51B that receives selection of the information B, a third checkbox 51C that receives selection of the information C, and a fourth checkbox 51D that receives selection of the information D are displayed as the checkboxes 51. The number of the checkboxes 51 is not limited to four but may be larger or smaller than four.

Here, in the setting screen shown in FIG. 7, one or more checkboxes 51 can be selected. In this setting screen, as one example, a checkmark is placed in the first checkbox 51A and the second checkbox 51B.

The page display part 52 is a part showing the page of the setting screen. As one example, “½” is displayed in the page display part 52 shown in FIG. 7, which shows that the first page of the total of two pages is displayed.

The previous page button 53 is a button for displaying the previous page of the setting screen. When the previous page button 53 is operated in the first page of the setting screen, the last page of the setting screen is displayed.

The next page button 54 is a button for displaying the next page of the setting screen. When the next page button 54 is operated in the last page of the setting screen, the first page of the setting screen is displayed.

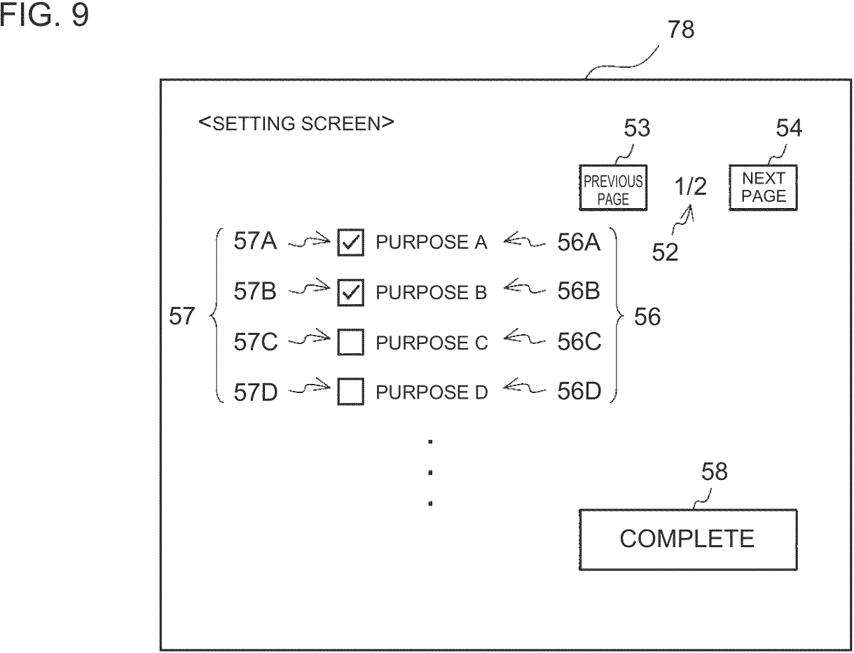

The OK button 55 is a button for completing the setting of the range of types of vehicle information to be provided to the user and displaying the setting screen shown in FIG. 9 that is used to set the range of purposes of use of the vehicle information to be provided to the user.

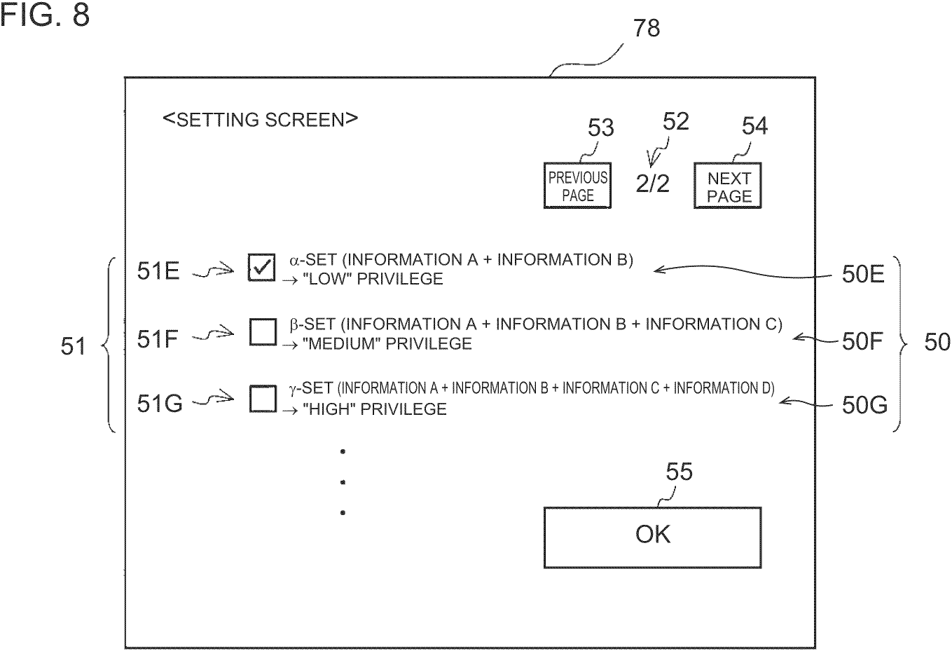

FIG. 8 is a second display example displayed on the monitor 78 of the vehicle 60. Specifically, the display example shown in FIG. 8 shows a state after the next page button 54 is operated in the setting screen shown in FIG. 7.

In the setting screen shown in FIG. 8, the information display part 50, checkboxes 51, the page display part 52, the previous page button 53, the next page button 54, and the OK button 55 are displayed.

As one example, the information display part 50 shown in FIG. 8 displays fifth information 50E showing a α-set which is composed of the information A and the information B and for which the privilege to be granted is “low,” sixth information 50F showing β-set which is composed of the information A, the information B, and the information C and for which the privilege to be granted is “medium,” and seventh information 50G showing a γ-set which is composed of the information A, the information B, the information C, and the information D and for which the privilege to be granted is “high.” The number of sets displayed in the information display part 50 is not limited to three but may be larger or smaller than three.

As one example, in FIG. 8, a fifth checkbox 51E that receives selection of the α-set, a sixth checkbox 51F that receives selection of the β-set, and a seventh checkbox 51G that receives selection of the γ-set are displayed as the checkboxes 51. The number of the checkboxes 51 is not limited to three but may be larger or smaller than three.

Here, in the setting screen shown in FIG. 8, one checkbox 51 can be selected. In this setting screen, as one example, a checkmark is placed in the fifth checkbox 51E.

As one example, “2/2” is displayed in the page display part 52 shown in FIG. 8, which shows that the last page of the total of two pages is displayed.

FIG. 9 is a third display example displayed on the monitor 78 of the vehicle 60. Specifically, the display example shown in FIG. 9 shows a state after the OK button 55 is operated in the setting screen shown in FIG. 7 or FIG. 8.

In the setting screen shown in FIG. 9, the page display part 52, the previous page button 53, the next page button 54, an information display part 56, checkboxes 57, and a complete button 58 are displayed.

As one example, “½” is displayed in the page display part 52 shown in FIG. 9, which shows that the first page of the total of two pages is displayed.

The information display part 56 is a part showing purposes of use of the vehicle information. As one example, the information display part 56 shown in FIG. 9 displays first information 56A showing that the purpose of use of the vehicle information is a purpose A, second information 56B showing that the purpose of use is a purpose B, third information 56C showing that the purpose of use is a purpose C, and fourth information 56D showing that the purpose of use is a purpose D. The number of the pieces of information displayed in the information display part 56 is not limited to four but may be larger or smaller than four.

The checkboxes 57 are portions that receive selection, by the driver, of the range of purposes of use of the vehicle information to be provided to the user. As one example, in FIG. 9, a first checkbox 57A that receives selection of the purpose A, a second checkbox 57B that receives selection of the purpose B, a third checkbox 57C that receives selection of the purpose C, and a fourth checkbox 57D that receives selection of the purpose D are displayed as the checkboxes 57. The number of the checkboxes 57 is not limited to four but may be larger or smaller than four.

Here, in the setting screen shown in FIG. 9, one or more checkboxes 57 can be selected. In this setting screen, as one example, a checkmark is placed in the first checkbox 57A and the second checkbox 57B.

The complete button 58 is a button for completing the setting of the provision range of the vehicle information to be provided to the user.

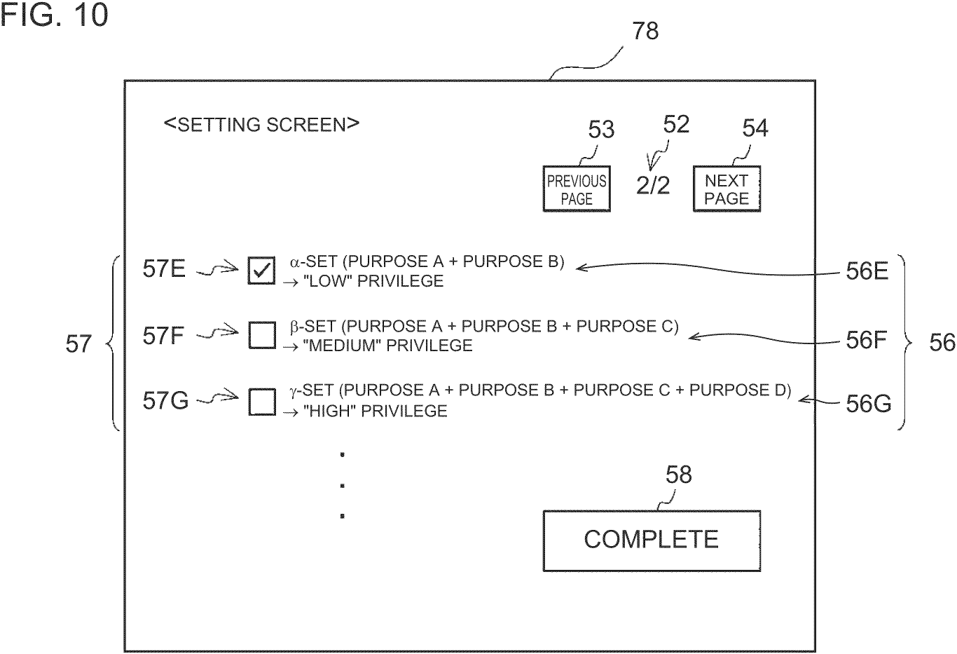

FIG. 10 is a fourth display example displayed on the monitor 78 of the vehicle 60. Specifically, the display example shown in FIG. 10 shows a state after the next page button 54 is operated in the setting screen shown in FIG. 9.

In the setting screen shown in FIG. 10, the page display part 52, the previous page button 53, the next page button 54, the information display part 56, checkboxes 57, and the complete button 58 are displayed.

As one example, “2/2” is displayed in the page display part 52 shown in FIG. 10, which shows that the last page of the total of two pages is displayed.

As one example, the information display part 56 shown in FIG. 10 displays fifth information 56E showing a α-set which is composed of the purpose A and the purpose B and for which the privilege to be granted is “low,” sixth information 56F showing β-set which is composed of the purpose A, the purpose B, and the purpose C and for which the privilege to be granted is “medium,” and seventh information 56G showing a γ-set which is composed of the purpose A, the purpose B, the purpose C, and the purpose D and for which the privilege to be granted is “high.” The number of sets displayed in the information display part 56 is not limited to three but may be larger or smaller than three.

As one example, in FIG. 10, a fifth checkbox 57E that receives selection of the α-set, a sixth checkbox 57F that receives selection of the β-set, and a seventh checkbox 57G that receives selection of the γ-set are displayed as the checkboxes 57. The number of the checkboxes 57 is not limited to three but may be larger or smaller than three.

Here, in the setting screen shown in FIG. 10, one checkbox 57 can be selected. In this setting screen, as one example, a checkmark is placed in the fifth checkbox 57E.

Next, display examples based on the provision process shown in FIG. 6 will be described.

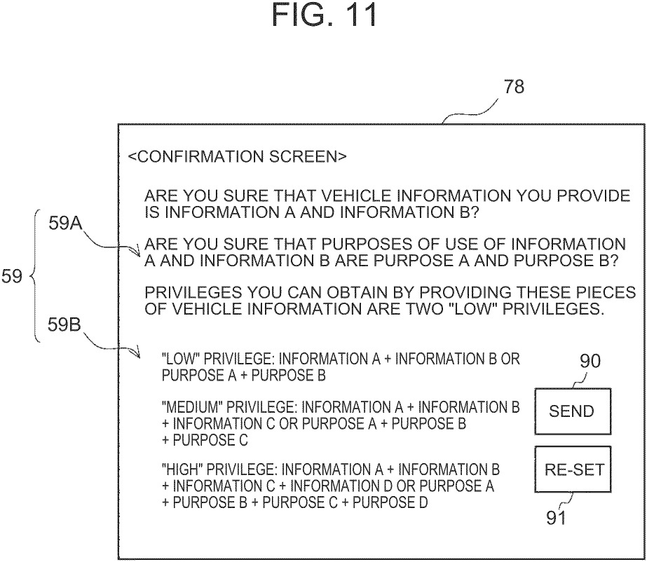

FIG. 11 is a fifth display example displayed on the monitor 78 of the vehicle 60. The CPU 21 of the business operator terminal 20 displays the confirmation screen shown in FIG. 11 on the monitor 78, for example, when the ignition switch of the vehicle 60 is turned off. As a premise for the following description, it is assumed that the complete button 58 has been operated in the setting screen shown in FIG. 9 or FIG. 10 and that the provision range of the vehicle information to be provided to the user has been set to the contents of this setting screen.

In the confirmation screen shown in FIG. 11, a message display part 59, a send button 90, and a re-set button 91 are displayed.

The message display part 59 is a part showing various messages to the driver, and includes a first message display part 59A and a second message display part 59B.

As one example, in FIG. 11, the first message display part 59A displays the following message: “Are you sure that vehicle information you provide is information A and information B? Are you sure that purposes of use of information A and information B are purpose A and purpose B? Privileges you can obtain by providing these pieces of vehicle information are two “low” privileges.” Thus, the first message display part 59A displays the range of types and the range of purposes of use of the vehicle information to be provided to the user that have been set by the driver, and the privileges that the driver is granted by providing the vehicle information to the user.

Further, in FIG. 11, the second message display part 59B displays the following message: “low” privilege: information A + information B or purpose A + purpose B, “medium” privilege: information A + information B + information C or purpose A + purpose B + purpose C, “high” privilege: information A + information B + information C + information D or purpose A + purpose B + purpose C + purpose D. Thus, the second message display part 59B displays combinations of the ranges of types and the ranges of purposes of use of the vehicle information for the respective privileges, the “low” privilege, the “medium” privilege, and the “high” privilege.

The send button 90 is a button for sending the vehicle information for which the provision range has been set by the driver to the user terminal 40.

The re-set button 91 is a button for re-setting the provision range of the vehicle information to be provided to the user. When the re-set button 91 is operated, the CPU 21 of the business operator terminal 20 makes the monitor 78 display the setting screen shown in FIG. 7, and makes the driver re-set the range of types and the range of purposes of use of the vehicle information in the setting screen shown in FIG. 7 or FIG. 8 and the setting screen shown in FIG. 9 or FIG. 10. When the complete button 58 is operated in the setting screen shown in FIG. 9 or FIG. 10 during re-setting of the provision range, the CPU 21 makes the monitor 78 display a confirmation screen for making the driver confirm the contents having been re-set.

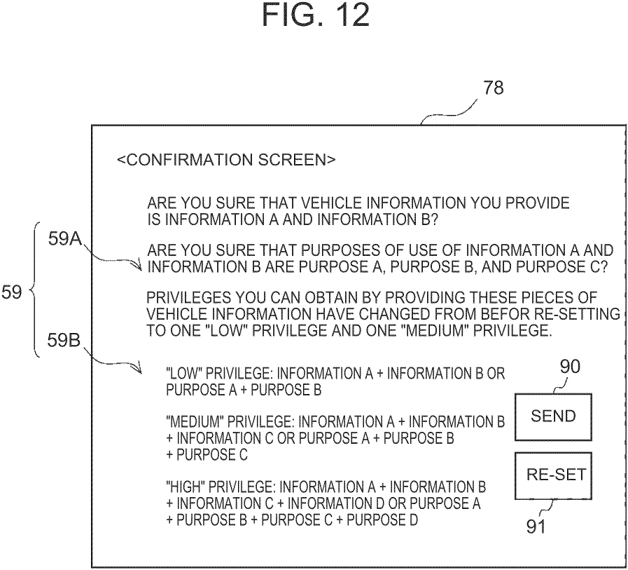

FIG. 12 is a sixth display example displayed on the monitor 78 of the vehicle 60. Specifically, the display example shown in FIG. 12 shows a state after the re-set button 91 is operated in the confirmation screen shown in FIG. 11 and the provision range of the vehicle information to be provided to the user is re-set.

In the confirmation screen shown in FIG. 12, the message display part 59, the send button 90, and the re-set button 91 are displayed.

As one example, in FIG. 12, the first message display part 59A displays the following message: “Are you sure that vehicle information you provide is information A and information B? Are you sure that purposes of use of information A and information B are purpose A, purpose B, and purpose C? Privileges you can obtain by providing these pieces of vehicle information have changed from before re-setting to one “low” privilege and one “medium” privilege.” Thus, the first message display part 59A displays that the privileges that the driver is granted by providing the vehicle information to the user have changed to one “low” privilege and one “medium” privilege as the range of purposes of use of the vehicle information to be provided to the user has expanded from that of FIG. 11.

As has been described above, in the business operator terminal 20, the CPU 21 receives setting, by the driver, of the provision range of the vehicle information to be provided to the user, before the vehicle information is provided to the user. Further, the CPU 21 acquires the vehicle information. Then, the CPU 21 provides the vehicle information that is included in the acquired provision range to the user. In this way, the vehicle information included in the provision range that is set before the vehicle information is provided is provided to the user, and thus the business operator terminal 20 can provide the vehicle information that is specified beforehand by the driver. Since the vehicle information included in the provision range that is set before the vehicle information is provided is provided to the user, the business operator terminal 20 can reduce the confirmation task performed by the driver when providing the vehicle information.

In the business operator terminal 20, as the provision range, the CPU 21 receives setting of the range of types and the range of purposes of use of the vehicle information permitted by the driver. Thus, the business operator terminal 20 can prevent a situation where vehicle information for which a range of types and a range of purposes of use not intended by the driver are set is provided to the user.

In the business operator terminal 20, the CPU 21 grants the driver a privilege based on the vehicle information having been provided to the user. The CPU 21 grants the driver a more advantageous privilege when the provision range is wider. Thus, according to the business operator terminal 20, the driver is expected to expand the provision range for the user to obtain an advantageous privilege, and the user can use valuable vehicle information.

In the business operator terminal 20, a plurality of privileges with varying degrees of advantageousness is provided. When providing the vehicle information to the user, the CPU 21 presents combinations of the provision ranges for the respective privileges. Thus, the business operator terminal 20 can provide the driver with criteria for determining whether to expand the provision range for the user.

In the business operator terminal 20, the CPU 21 receives re-setting of the provision range when providing the vehicle information to the user. Thus, when providing the vehicle information to the user, the business operator terminal 20 allows the provision range that has been once set to be expanded or narrowed according to the privilege that the driver desires to obtain.

In the business operator terminal 20, as the timing of providing the vehicle information to the user, the CPU 21 receives re-setting of the provision range in the confirmation screen that makes the driver confirm the vehicle information to be provided to the user. Thus, the business operator terminal 20 allows the driver to confirm the vehicle information of which the provision range has been re-set.

### Second Embodiment

Next, a second embodiment will be described while overlaps with the other embodiment will be omitted or abbreviated.

In the second embodiment, unlike in the first embodiment, the acquisition unit 21B acquires vehicle information that is included in the provision range received by the reception unit 21A. Thus, the business operator terminal 20 according to the second embodiment can prevent vehicle information not intended by the driver from being acquired.

### Others

In the above embodiments, the business operator terminal 20 has been described as one example of the information processing device. However, the present disclosure is not limited to this example, and the on-board equipment 15 installed in the vehicle 60 may be one example of the information processing device. Thus, the information processing system 10 is not limited to the configuration in which the business operator terminal 20 sends the vehicle information acquired from the vehicle 60 to the user terminal 40, and may adopt a configuration in which the driver transmits the vehicle information that the driver has specified beforehand directly from the vehicle 60 to the user terminal 40.

In the above embodiment, as the provision range, setting of the range of types and the range of purposes of use of the vehicle information permitted by the driver is received. Instead of or in addition to these ranges, setting of a range of provision destinations of the vehicle information may be received. “Provision destinations of the vehicle information” refer to arbitrary users selected by the driver from among a plurality of users.

In the above embodiment, the driver is granted a more advantageous privilege when the provision range is wider. However, the condition for granting an advantageous privilege is not limited to this example. For example, instead of or in addition to this condition, the privilege granted to the driver may be changed according to the type of the vehicle information to be provided to the user. Specifically, among pieces of vehicle information, images taken by the camera 76 and the current position of the vehicle 60 measured by the GPS device 80 may be regarded as personal information that allows identification of an individual, and when the personal information is included in the vehicle information to be provided to the user, the driver may be granted a more advantageous privilege than when the personal information is not included.

In the above embodiment, combinations of the ranges of types and the ranges of purposes of use of the vehicle information have been presented as combinations of the provision ranges for the respective privileges. However, the present disclosure is not limited to this example, and either the combinations of the ranges of types of the vehicle information or the combinations of the ranges of purposes of use of the vehicle information may be presented.

In the above embodiment, re-setting of the range of types and the range of purposes of use of the vehicle information is received. However, the present disclosure is not limited to this example, and re-setting of one of the range of types of the vehicle information and the range of purposes of use of the vehicle information may be received.

In the above embodiment, in the information processing system 10, the vehicle information is shared in the block chain among the business operator terminal 20, the user terminal 40, and the on-board equipment 15 installed in the vehicle 60. However, the present disclosure is not limited to this example, and a common application may be installed in the business operator terminal 20, the user terminal 40, and the vehicle 60 and the vehicle information may be shared in this application.

In the above embodiment, the send button 90 is displayed in the confirmation screen, and the vehicle information is sent to the user terminal 40 as the send button 90 is operated. However, the present disclosure is not limited to this example. The send button 90 may not be displayed in the confirmation screen, and the vehicle information may be sent to the user terminal 40 when a certain time has elapsed without the re-set button 91 being operated since the confirmation screen has been displayed.

In the above embodiment, at least some of the functional components of the CPU 21 of the business operator terminal 20 shown in FIG. 4 may be realized by the CPU 61 of the on-board equipment 15 shown in FIG. 5. In this case, the provision process shown in FIG. 6 is executed by one processor of the CPU 21 of the business operator terminal 20 or the CPU 61 of the on-board equipment 15, or by a combination of a plurality of processors including the CPU 21 of the business operator terminal 20 and the CPU 61 of the on-board equipment 15.

The provision process that is executed as the CPU 21 reads software (program) in the above embodiment may be executed by various processors other than the CPU. Examples of processors in this case include a programmable logic device (PLD), such as a field-programmable gate array (FPGA), of which the circuit configuration can be changed after manufacturing, and a dedicated electric circuit, such as an application-specific integrated circuit (ASIC), that is a processor with a circuit configuration specially designed to execute a specific process. The provision process may be executed by one of these various processors, or may be executed by a combination of two or more processors of the same type or different types (e.g., a combination of a plurality of FPGAs, or a combination of a CPU and an FPGA). The hardware structure of these various processors is, more specifically, an electric circuit combining circuit elements including semiconductor elements.

In the above embodiment, the form in which the information processing program 24A is stored (installed) beforehand in the storage unit 24 has been described, but the present disclosure is not limited to this example. The information processing program 24A may be provided in the form of being recorded in a recording medium (storage medium), such as a compact disk read-only memory (CD-ROM), a digital versatile disk read-only memory (DVD-ROM), or a universal serial bus (USB) memory. Further, the information processing program 24A may be provided in the form of being downloaded from an external device through the network N.

What is claimed is:

1. An information processing device comprising:
a reception unit that receives setting, by a driver of a vehicle, of a provision range of vehicle information about the vehicle to be provided to a user who wishes to use the vehicle information, before the vehicle information is provided to the user;
an acquisition unit that acquires the vehicle information; and
a provision unit that provides the vehicle information that is included in the provision range acquired by the acquisition unit to the user.

2. The information processing device according to claim 1, wherein, as the provision range, the reception unit receives setting of a range of at least one of types, provision destinations, and purposes of use of the vehicle information permitted by the driver.

3. The information processing device according to claim 1, comprising a granting unit that grants the driver a privilege based on the vehicle information having been provided to the user, wherein the granting unit grants the driver a more advantageous privilege when the provision range is wider.

4. The information processing device according to claim 3, wherein:
a plurality of privileges with varying degrees of advantageousness is provided; and
the information processing device comprises a presentation unit that presents combinations of the provision ranges for the respective privileges when the provision unit provides the vehicle information to the user.

5. The information processing device according to claim 1, comprising a setting unit that receives re-setting of the provision range when the provision unit provides the vehicle information to the user.

6. The information processing device according to claim 5, wherein, as a timing when the provision unit provides the vehicle information to the user, the setting unit receives re-setting of the provision range in a confirmation screen that makes the driver confirm the vehicle information to be provided to the user.

7. The information processing device according to claim 1, wherein the acquisition unit acquires the vehicle information that is included in the provision range received by the reception unit.

8. An information processing method in which a computer executes the following processes:
receiving setting, by a driver of a vehicle, of a provision range of vehicle information about the vehicle to be provided to a user who wishes to use the vehicle information, before the vehicle information is provided to the user;
acquiring the vehicle information; and
providing the vehicle information that is included in the acquired provision range to the user.

9. A non-transitory storage medium that stores an information processing program that makes a computer execute the following processes:
receiving setting, by a driver of a vehicle, of a provision range of vehicle information about the vehicle to be provided to a user who wishes to use the vehicle information, before the vehicle information is provided to the user;
acquiring the vehicle information; and
providing the vehicle information that is included in the acquired provision range to the user.
